(19) United States
(12) Patent Application Publication
(10) Pub. No.: US 2026/0160719 A1
(43) Pub. Date: Jun. 11, 2026

(54) SYSTEM AND METHOD FOR SENSING OF ANALYTE CONCENTRATIONS

(71) Applicant: VOCAI MEDICAL LTD, Hod Hasharon (IL)

(72) Inventor: Yehuda SHEN BAHAR, Yehud-Monnoson (IL)

(73) Assignee: c/o VOCAI MEDICAL LTD, Hod Hasharon (IL)

(21) Appl. No.: 19/385,900

(22) Filed: Nov. 11, 2025

Related U.S. Application Data
(63) Continuation of application No. PCT/IB2024/054531, filed on May 9, 2024.
(60) Provisional application No. 63/465,888, filed on May 12, 2023.

(51) Int. Cl. G01N 27/02

(52) U.S. Cl. CPC G01N 27/02

(57) ABSTRACT

A system including a sensing field effect transistor (FET) including a first source region, first drain region, and a first sensing region; a reference FET, substantially identical to the sensing FET or sized according to a scaling factor relative to the sensing FET and including a second source region, second drain region, and a top gate formed from a covered second sensing region, and a controller configured to determine a voltage applied to the top gate that results in an electric field in the second sensing region that matches an electric field in the first sensing region.

### CROSS REFERENCE TO RELATED APPLICATIONS

This application claims priority from U.S. Provisional Patent Application No. 63/465,888 filed on May 12, 2023, which is expressly incorporated herein by reference in its entirety.

### FIELD

Embodiments disclosed herein relate generally to semiconductor chemical sensors, and more particularly to sensors based on field effect transistors (FETs) and methods of calibration thereof.

### BACKGROUND

Gas sensors based on nanowires of various materials, for example Si, ZnO, SnO, and other materials, can exhibit exceptionally high resolution and sensitivity. However, the manufacture of commercial gas sensors based on such nanowires may not be currently feasible, since the fabrication of these structures may be complicated and not reproducible.

### SUMMARY

Embodiments disclosed include systems and methods for measuring of the concentration of analytes using dual multi-gate FETs. Specific embodiments provide a system and method for calibration of such analyte-sensing FETs. A dual multi-gate FET system disclosed herein may be calibrated and configured for sensing different gas or liquid analytes, for example for medical, environmental, military, agriculture, law enforcement or other applications.

In the description below, semiconductor gate regions of multi-gate FETs may be simply referred to as “gates”. Similarly, source and drain regions may be referred to simply as “source” and “drain”. As described herein, a sensing FET may include a sensing region where the gas or liquid influences a source-drain current due to a field effect. An essentially identical reference FET may be provided on a same silicon substrate, featuring the same source, drain and gate structures but with a top gate covering the sensing region.

In a calibration process described herein, a controller may be provided that adjusts the voltages applied to the sources, drains and gates to thereby determine a “base voltage” of the top gate when the sensing region is not exposed to an analyte, and to measure corresponding “analyte voltages” of the top gate when the sensing region is exposed to an analyte. Having completed the calibration, these measured voltages of the top gate can then be used to determine the concentration of an analyte.

In some disclosed embodiments, a system includes: a sensing field effect transistor (FET) including a first source region, first drain region, and a first sensing region; a reference FET, substantially identical to the sensing FET or sized according to a scaling factor relative to the sensing FET and including a second source region, second drain region, and a top gate formed from a covered second sensing region; and a controller configured to determine a base voltage applied to the top gate that results in an electric field in the second sensing region that matches an electric field in the first sensing region.

In some embodiments, the controller uses a measured current to provide an indication of the electric field in the sensing FET and the reference FET, wherein the measured current is the current between the first source and drain regions and the current between the second source and drain regions. In some embodiments, the controller uses measurable parameters that provide an indication of the electric field or of a work function in the sensing FET and the reference FET.

In some embodiments, the sensing FET further includes a first lateral gate or first back gate, and wherein the reference FET further includes a second lateral gate or second back gate. In some embodiments, the controller is further configured to apply voltages to the first lateral gate or first back gate and to the second lateral gate or second back gate to thereby induce a conducting channel in both of the sensing and reference FETs for current flow therethrough from the respective source to drain regions.

In some disclosed embodiments, a method for calibrating a sensing FET, includes; providing the sensing FET including a source region, drain region, and a first sensing region; providing a reference FET having substantially the same structure and materials as the sensing FET and further including a top gate formed from a covering over a second sensing region of the reference FET; and providing a controller configured to determine a base voltage applied to the top gate that results in an electric field in the second sensing region that matches an electric field in the first sensing region.

In some embodiments, the method further includes, when the sensing FET is exposed to an analyte, using the controller to determine an analyte voltage applied to the top gate that results in an electric field in the second sensing region that matches an electric field in the first sensing region.

In some embodiments, the method further includes, when the sensing FET is exposed to an analyte, using the controller to determine an analyte voltage applied to the top gate when a measured current between the source and drain regions of the sensing FET is equivalent to the measured current between the source and drain regions of the reference FET.

In some embodiments, the sensing FET further includes at least one of a first lateral gate or first back gate, and wherein the reference FET further includes at least one of a second lateral gate or second back gate.

This Summary is provided to introduce a selection of concepts in a simplified form that are further described in the Detailed Description below. It may be understood that this Summary is not intended to identify key features or essential features of the claimed subject matter, nor is it intended to be used to limit the scope of the claimed subject matter. The details of one or more implementations are set forth in the accompanying drawings and the description below. Other features will be apparent from the description and drawings.

### BRIEF DESCRIPTION OF THE DRAWINGS

Non-limiting examples of embodiments disclosed herein are described below with reference to figures attached hereto that are listed following this paragraph. The drawings and descriptions are meant to illuminate and clarify embodiments disclosed herein and should not be considered limiting in any way. Like elements in different drawings may be indicated by like numerals. Elements in the drawings are not necessarily drawn to scale.

FIGS. 1A-1C illustrate a system for measuring the concentration of an analyte according to some implementations;

FIG. 2 illustrates a flow chart of a process for detecting concentration of an analyte according to some implementations.

### DETAILED DESCRIPTION

U.S. Pat. Nos. 10,054,562B2 and 11,112,379B2 disclose multi-gate FETs with a conducting channel that acts like a virtual buried nanowire, whose conductivity is sensitive to a local concentration of molecules from a gas or liquid sample adhering to a surface of the FET. The position and size of the conducting channel is controllable by the gates, allowing the FET to function as a molecular sensor with improved sensitivity.

Such multi-gate FET molecular sensors may be much cheaper to mass produce than a conventional nanowire molecular sensor using a real physical nanowire. For example, such a multi-gate FET might be produced with conventional high-volume, low-cost CMOS manufacturing methods, since no low-dimensional design rules are needed.

While such multi-gate FETs provide for nanowire-like gas sensing, they may not be accurate when deployed in actual sensing devices, as they lack mechanisms for calibration (to accommodate manufacturing differences between FETs) and adaptation to different environments.

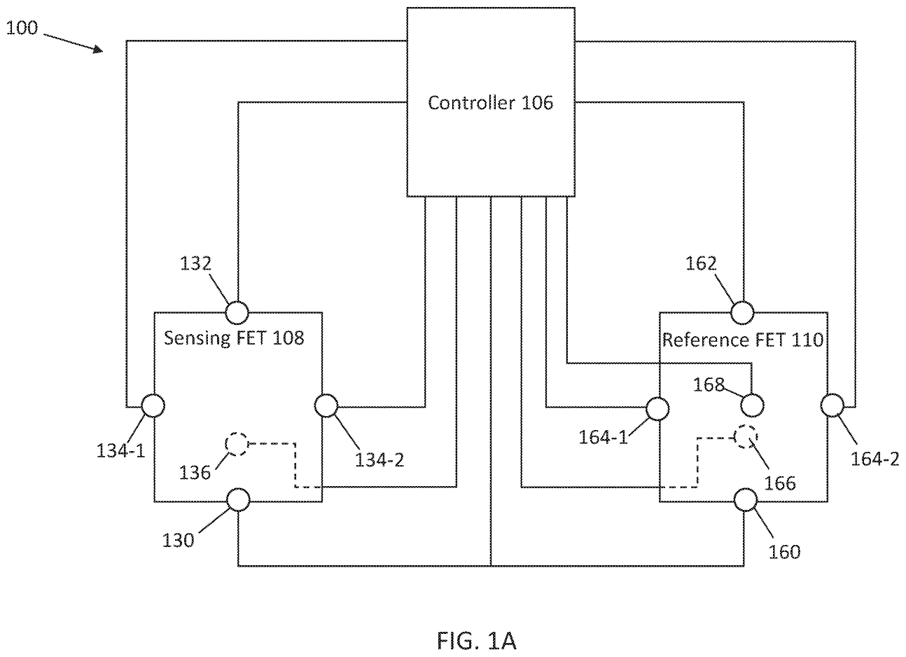

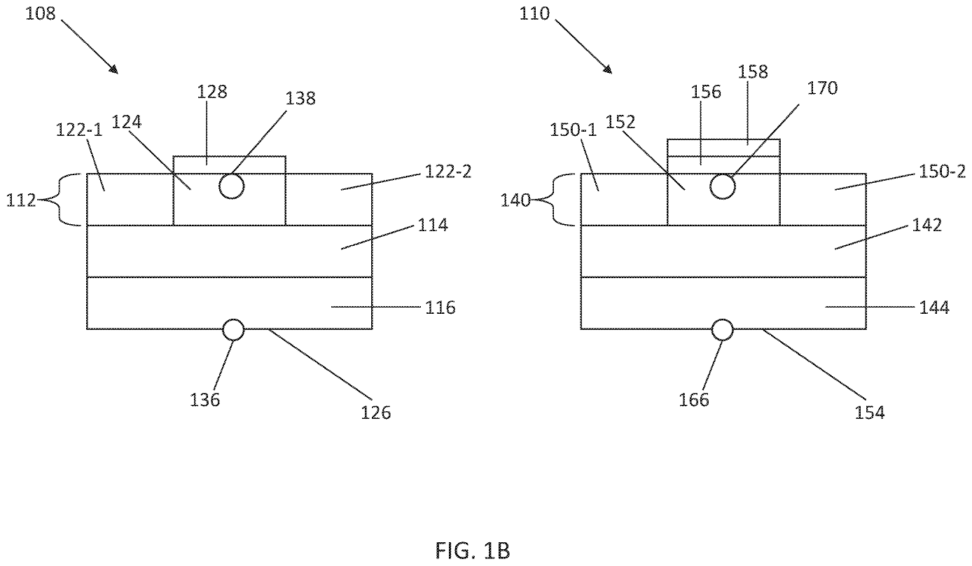

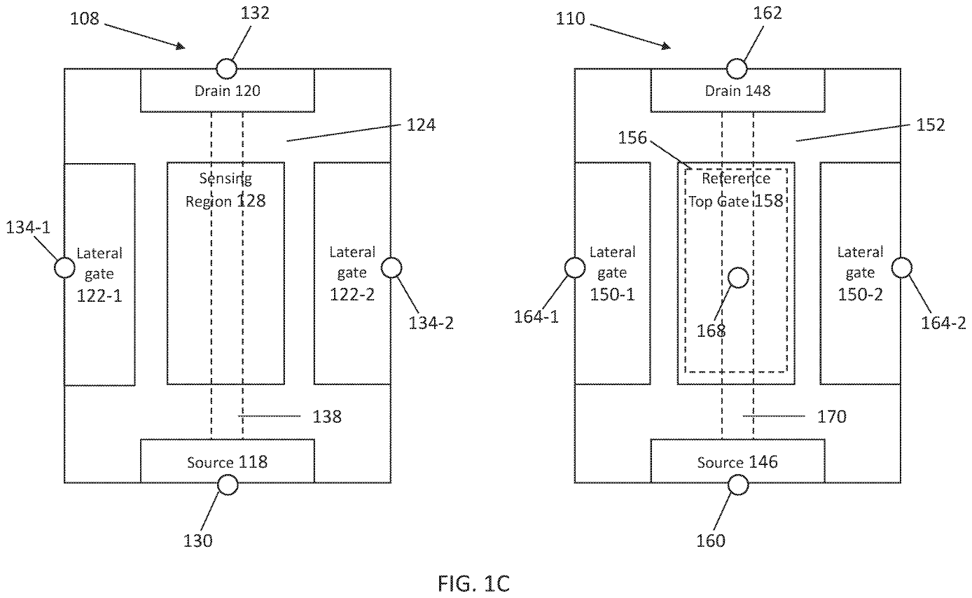

Embodiments disclosed herein provide for systems and methods for measuring the concentration of an analyte and for calibrating a multi-gate FET used for sensing of an analyte. FIGS. 1A-1C illustrate a system 100 for measuring the concentration of an analyte according to some implementations. System 100 may include a controller 106, a sensing FET 108, and a reference FET 110. In some embodiments, FETs 108 and 110 may be multi-gate FETs.

Sensing FET 108 may include a semiconductor layer 112 built on top of an insulator layer 114. In some embodiments, insulator layer may be a buried oxide (BOX) layer including silicon oxide and/or other materials, for example, HfO₂, Si₃N₄, Al₂O₃, and Ta₂O₅. In some embodiments, insulator layer 114 may be built on top of a substrate 116. In some embodiments, substrate 116 may be made of the same material as semiconductor layer 112, for example silicon.

Semiconductor layer 112 may include a source region 118 and a drain region 120. In some embodiments, semiconductor layer 112 may include an active region 124 connecting the source region 118 to the drain region 120. In some embodiments, semiconductor layer 112 may further include a first lateral-gate region 122-1 partially extending between the source 118 and drain 120 regions, and a second lateral-gate region 122-2 partially extending between the source 118 and drain 120 regions. In some embodiments, semiconductor layer 112 may include only one lateral gate region (such as 122-1 or 122-2). In some embodiments, where semiconductor layer 112 includes lateral gate regions 122, active region 124 connecting the source region 118 to the drain region 120 may extend between the lateral gate areas 122. In some embodiments, the bottom of substrate 116 or the bottom of insulator layer 114 (if there is no substrate 116 beneath insulator layer 114) may form a back gate region 126. In some embodiments, back gate region 126 may be provided instead of one or both of lateral gate regions 122.

In some embodiments, a dielectric layer 128 (also referred to herein as a “sensing region” 128) may be placed above a portion of active region 124. In some embodiments, dielectric layer 128 may be made of silicon oxide. Alternatively, other materials may be used for dielectric layer 128, including for example any of HfO₂, Si₃N₄, Al₂O₃, and Ta₂O₅.

Regions 118, 120, 122-1, 122-2 and 126 of sensing FET 108 may be connected to controller 106 by, respectively source electrode 130, drain electrode 132, first lateral electrode 134-1 second lateral electrode 134-2, and back gate electrode 136. In use, voltages applied to electrodes 130, 132, 134-1, 134-2 and 136 may create a conducting channel 138 in active region 124 of FET 110. In some embodiments, in reaction to the presences of an analyte, the conductivity of conducting channel 138 may change thereby altering the current flowing from source region 118 to drain region 120 as measured by controller 106.

In some embodiments, sensing FET 108 may thus include at least source region 118, drain region 120, and sensing region 128 (on top of active region 124), where conducting channel 138 is determined by the structure of sensing FET 108 (i.e.: the relative sizes and materials used in source region 118, drain region 120, and sensing region 128) and the voltages applied to source region 118 and drain region 120. In some embodiments, sensing FET 108 may further include at least one gate region such as lateral gate regions 122-1, 122-2, and/or back gate 126, where conducting channel 138 is determined by the structure of sensing FET 108 and the voltages applied to the gate regions.

Reference FET 110 has the same structure and materials as sensing FET 108. In some embodiments, reference FET 110 may be sized according to a scaling factor relative to sensing FET 108. For example, reference FET 110 may be 2× the size (L×W×H) of sensing FET 108. In some embodiments, reference FET 110 may include a semiconductor layer 140 built on top of an insulator layer 142. In some embodiments, insulator layer 142 may be a BOX layer including silicon oxide and/or other materials, for example, HfO₂, Si₃N₄, Al₂O₃, and Ta₂O₅. In some embodiments, insulator layer 142 may be built on top of a substrate 144. In some embodiments, substrate 144 may be made of the same material as semiconductor layer 140 or a portion of semiconductor layer 140, for example silicon.

Semiconductor layer 140 may include a source region 146 and a drain region 148. In some embodiments, semiconductor layer 140 may include an active region 152 connecting the source region 146 to the drain region 148. In some embodiments, semiconductor layer 140 may further include a first lateral-gate region 150-1 partially extending between the source 146 and drain 148 regions, and a second lateral-gate region 150-2 partially extending between the source 146 and drain 148 regions. In some embodiments, semiconductor layer 140 may include only one lateral gate region (such as 150-1 or 150-2). In some embodiments, where semiconductor layer 140 includes lateral gate regions 150, active region 152 connecting the source region 146 to the drain region 148 may extend between the lateral gate areas 150. In some embodiments, the bottom of substrate 144 or the bottom of insulator layer 142 (if there is no substrate 144 beneath insulator layer 142) may form a back gate region 154. In some embodiments, back gate region 154 may be provided instead of one or both of lateral gate regions 150.

In some embodiments, a dielectric layer 156 may be placed above a portion of active region 154. In some embodiments, dielectric layer 156 is made of silicon oxide. Alternatively, other materials may be used for dielectric layer 156 (also “sensing region 156” herein), including for example any of HfO₂, Si₃N₄, Al₂O₃, and Ta₂O₅. Dielectric layer 156 may be covered by a covering 158 (also referred to herein as “reference top gate” 158) such that reference FET 110 is not affected by the presence of an analyte. In some embodiments, reference top gate 158 may be formed of a material similar to any of regions 146, 148 or 150. In some embodiments, reference top gate 158 may be formed from aluminum, polysilicon, TiN, TiAIN or a combination of these. In some embodiments, reference FET 110 may be partially or entirely coated with a coating to prevent any influence on the behavior FET 108 by the environment of FET 108 or any analyte.

The regions 146, 148, 150-1, 150-2, 154 and 156 of reference FET 110 may be connected to controller 106 by, respectively source electrode 160, drain electrode 162, first lateral electrode 164-1 second lateral electrode 164-2, back gate electrode 166, and top gate electrode 168. In use, voltages applied to electrodes 160, 162, 164-1, 164-2, 166 and 168 may create a conducting channel 170 in active region 152 of FET 108. In some embodiments, in reaction to varying of the voltage applied to reference top gate 156, the conductivity of conducting channel 170 may change thereby altering the current flowing from source region 146 to drain region 148 as measured by controller 106.

In some embodiments, reference FET 110 may thus include a source region 146, drain region 148, sensing region 156 (on top of active region 152) and top gate 158, where conducting channel 170 is determined by the structure of reference FET 110 (i.e. the relative sizes and materials used in source region 146, drain region 148, and sensing region 156) and the voltages applied to source region 146 and drain region 148. In some embodiments, reference FET 110 may further include at least one gate region such as lateral gate regions 150-1, 150-2, and/or back gate 154, where conducting channel 170 is determined by the structure of reference FET 110 and the voltages applied to the gate regions.

In some embodiments, system 100 may be implemented as an integrated circuit (IC). In some embodiments, source regions 118, 146 and/or drain regions 120, 148 may include heavily doped N-type silicon (N+). In some embodiments, lateral-gate areas 122 and 150 may include heavily doped P-type silicon (P+). In some embodiments, conducting channels 138 and 170 may be constrained to have the lateral dimensions of a nanowire.

In some embodiments, dielectric layer 128 may be chemically treated, for example, an SiO2 dielectric may be modified with APTMS ((3-aminopropyl) trimethoxysilane), or with APTES ((3-Aminopropyl) triethoxysilane), or in other ways. In some embodiments, dielectric layer 128 may be modified by coating it with a ligand, so that it binds specifically to the gas molecules that are to be sensed, in a “lock and key” configuration. Alternatively, in some embodiments, the dielectric layer 128 may be chemically treated with a ligand that does not bind only to the gas molecules to be sensed. For example, the ligand may also bind to one or more other gas molecules that are potentially present in an environment where the system 100 is designed to be used.

In some embodiments, dielectric layer 128 may be enhanced by coating it with nanoparticles, which may be ceramic (e.g., TiO2, ZnO, Al2O3, WO3) or metallic (e.g., gold, silver, palladium, platinum). In some embodiments, dielectric layer 128 may also be coated with additional layers, such as silanes, conductive polymers, or non-conductive polymers. Furthermore, in some embodiments, combinations of the aforementioned methods of modification and coating could be employed to enhance the functionality of dielectric layer 128.

In some embodiments, active regions 124, 152 may include a heater (not shown) configured to heat active regions 124, 152. In some embodiments, such a heater may be formed of polysilicon and/or tungsten. In some embodiments, heating of active regions by the heater may allow selective sensing of different analytes.

It should be appreciated that, as mentioned above, sensing FET 108 and reference FET 110 have the same structure and are formed of the same materials (including substrates, semiconducting regions, dielectrics, ligands, and so forth) and may be considered to be identical (within given manufacturing tolerances) aside from reference top gate 158 (and associated electrode 168) of reference FET 110. Thus, an applied voltage to reference top gate 158 of reference FET 110 may simulate the effect of an analyte sensed by reference FET 110. Where reference FET 110 is sized according to a scaling factor relative to sensing FET 108, this scaling factor may be taken into account when determining the voltage applied to reference top gate 158.

In some embodiments, in use, a voltage applied to one or more of the lateral gate electrodes 122, 150, back gate electrodes 136, 166, and top electrode 168 in reference FET 110 creates an electric field in respectively semiconductor layers 112, 140, which creates a depletion region without charge carriers at the interface of the lateral regions 122, 150 with active regions 124, 152 therebetween. For appropriate values of the gate voltages, the depletion region covers much of the active regions 124, 152, leaving only a relatively narrow undepleted conducting channels 138, 170. Varying of the gate voltages applied thus may define the width and depth of conducting channels 138 and 170. When a voltage is then applied between sources 130, 160 and drain electrodes 132, 162, a current flows between them which depends on the cross-sectional area of conducting channels 138, 170.

Controller 106 may include a processor and a non-transitory computer readable medium such as memory containing instructions configured such that when executed by the at least one processor enable controller 106 to perform the functions and/or operations necessary to provide the functionality described herein. Controller 106 may be a computing device as defined herein. In some embodiments, controller may include an analog feedback system. Controller 106 may apply voltages to electrodes 130, 132, 134, 136, 160, 162, 164, 166 and 168. Controller 106 may measure the current flow from source regions to drain regions (118 to 120 and 146 to 148) or other measurement parameters such as but not limited to current flow from other electrodes, voltage changes, impedances and so forth. Controller 106 may manage the operation of system 100 including control of FETs 108 and 110.

Where system 100 may be said herein to provide specific functionality or perform actions or processes, it should be understood that the functionality or actions are performed by controller 106 that may perform the functionality or actions or may utilize FETs 108, 110 for performing functionality or actions. In some embodiments, controller 106 may be in data communication with an external computing device (not shown), the external computing device receiving measurement data (such as the voltages applied, voltages or currents measured, and reference voltage of reference top gate 158) from controller 106 to perform analysis of analyte concentrations by the external computing device.

In some embodiments, an array of sensing FET 108 and reference FET 110 pairs may be used, with the dielectric layers 128, 156 of the different FET pairs having different chemical treatments, such that different types of gas molecules may have different relative tendencies to bind to the different sensing FETs 110 in the array. Alternatively or additionally, different sensing FETs 110 in the array may have different sensitivities to one type of molecule, even if that is the only type of molecule that the sensor is designed to detect. In such an array, each pair of reference and sensing FETs 108 and 110 are essentially identical (within given manufacturing tolerances) aside from reference top gate 158 (and associated electrode 168) of reference FET 110. In some embodiments, in such an array, reference FET 110 is sized according to a scaling factor relative to sensing FET 108 and this scaling factor may be taken into account when determining the voltage applied to reference top gate 158.

It should be appreciated that the principles described herein may be applied to a sensing FET 108 having a different structure or using different materials to provide a conducting channel affected by a field change induced by the presence of an analyte as long as the accompanying reference FET was provided with the same structure and materials as well as a controllable reference gate. Alternatively, an actual nanowire might be used for sensing in sensing FET 108 along with a nanowire in reference FET 110 for reference.

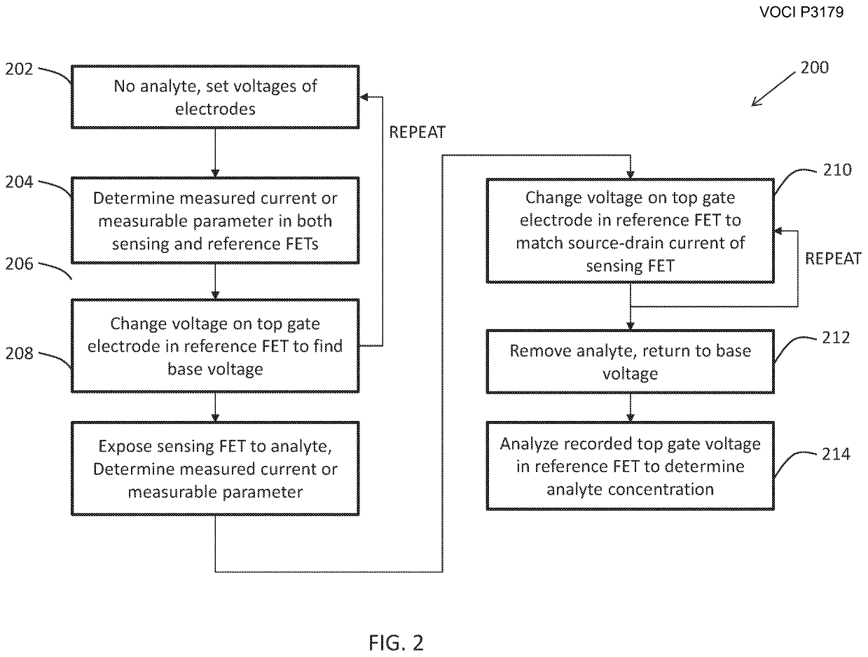

FIG. 2 illustrates a flow chart of a process 200 for detecting concentration of an analyte according to some implementations. Process 200 may be performed by system 100 as described above. A non-transitory computer readable medium may contain instructions that when executed by at least one processor performs the operations described at each step as part of process 200. The non-transitory computer readable medium and at least one processor may correspond to controller 106.

In step 202, calibration of system 100 is started where sensing region 128 is not exposed to an analyte by setting (by the controller) of the voltages of source electrodes 130 and 160 to the same value and setting the voltages at lateral electrodes 134 and 164 to (the same) values sufficient to create conducting channels 138 and 170. In some embodiments, a voltage may be applied to drain electrodes 132 and 162. In some embodiments, where a back gate 126 or 154 is provided, a back gate voltage is also applied to back gate electrodes 136 or 166 to adjust the size and position of conducting channels.

Alternatively, where only one lateral gate is provided or when only a back gate and no lateral gate (or a single lateral gate) are provided, the voltages of the provided back and/or lateral gates are set to create a conducting channel of the desired size and position.

Alternatively, where no lateral or back gates are provided, sensing FET 108 and reference FET 110 are configured to enable current flow from the respective sources to drains according to the voltages applied to the source and optionally drain regions. In some embodiments, voltages applied to respective gates of the sensing FET 108 and reference FET 110 may be substantially identical.

As part of step 202, the voltage of top electrode 168 may be set to an initial value. The voltage settings as described herein are measured, for example, relative to ground, and typically source electrodes 130, 160 may be grounded.

In step 204, controller 106 is configured to determine a voltage applied to top electrode 168 that results in an electric field in the covered sensing region that matches an electric field in the first sensing region. For example, the current flowing from each source-drain electrode pair (118-120 and 124-148) is measured by controller 106 (referred to herein as the “measured current”). Alternatively, in some embodiments, controller 106 may use other “measurable parameters” that may provide an indication of the electric field or of the work function present in the sensing FET 108 and the reference FET 110 instead of using the measured current. In some embodiments, measurable parameters may include but are not limited to a threshold voltage of the FET, a saturation current, other device currents, device impedances and so forth.

In step 206, the voltage applied to top electrode 168 is changed to thereby affect the size and position of conducting channel 170 until the measured current in reference FET 110 (between source electrode 160 to drain electrode 162) is the same as the measured current in sensing FET 108 (between source electrode 130 to drain electrode 132). Alternatively, the voltage applied to top electrode 168 is changed until the measurable parameter measured in reference FET 110 matches the measurable parameter measured in sensing FET 108. The top electrode voltage at which the measured currents or measurable parameter is the same is referred to herein as the “base voltage” at which sensing FET 108 is not exposed to an analyte. Steps 202-206 may then be repeated several times with different voltages applied to source electrodes 130 and 160, drain electrodes 132 and 162, lateral electrodes 134 and 164 and/or back gate electrodes 136 and 166) to thereby determine a range of base voltages of top electrode 168 associated with these applied voltages. It should be appreciated that the voltage applied to top electrode 168 as described herein may be measured as a voltage or may be determined using some other measurement technique related to the voltage (such as impedance of another circuit element connected to top electrode 168).

Where reference FET 110 is sized according to a scaling factor relative to sensing FET 108, the voltage applied to top electrode 168 is changed to thereby affect the size and position of the conducting channel 170 until the measured current in the reference FET 110 (between source electrode 160 to drain electrode 160) is the related to the measured current in the sensing FET 108 according to the scaling factor (between source electrode 130 to drain electrode 132). The scaling factor may also be applied to a measurable parameter when such a measurable parameter is used as an alternative to the measured current.

In step 208, sensing FET 108 is exposed to the analyte of interest which may cause the measured current in FET 110 to change due to exposure of the sensing region 128 to the analyte. In step 210, the top electrode voltage is changed until the measured current of reference FET 110 is equal to that of sensing FET 108 to thereby determine an “analyte voltage” of the top electrode. Step 210 may then be repeated periodically to determine a range of analyte voltages.

Where reference FET 110 is sized according to a scaling factor relative to sensing FET 108, the top electrode voltage is changed until the measured current of reference FET 110 is the related to the measured current in the sensing FET 108 according to the scaling factor to thereby determine an “analyte voltage” of the top electrode. The scaling factor may also be applied to a measurable parameter when such a measurable parameter is used as an alternative to the measured current. Thus, the measured current in sensing FET 108 with a specific geometry may be used to calculate the measured current for different geometry reference FET 110. In a non-limiting example, if reference FET 110 is twice the length of sensing FET 108, the scaled measured current of reference FET 110 may be calculated by dividing it to determine what the measured current would be if it was the same size as sensing FET 108, and then using reference FET 110 as described herein to calibrate sensing FET 108.

In step 212, the analyte may be removed, and step 210 may be repeated periodically until it has been determined that the analyte is no longer present as the top electrode voltage has returned to the base voltage of step 206.

In step 214, the recorded changing top electrode analyte voltages may be used by controller 106 to determine the concentration of the analyte that sensing FET 108 was exposed to. Alternatively, the recorded changing top electrode analyte voltages may be transmitted to an external system (not shown) for analysis. Following the calibration of process 200, a particular voltage applied to reference top gate 158 may be said to represent the concentration of an analyte that sensing FET 108 is exposed to. It should be appreciated that, having been calibrated, voltages applied to reference top gate 158 may henceforth be used as a basis for assessing the concentration of an analyte sensed by sensing FET 108 regardless of the measured current.

Unless otherwise defined, all technical and scientific terms used herein have the same meaning as commonly understood by one of ordinary skill in the art. The materials, methods, and examples provided herein are illustrative only and not intended to be limiting.

The terms “substrate” and/or “wafer”, as used herein, may relate to a thin slice of semiconductor material, for example, a silicon crystal, which may be used in fabrication of integrated circuits and/or any other microelectronic devices. For example, the wafer may serve as the substrate for the microelectronic devices, which may be built in and over the wafer. The term “Integrated Circuit” (IC), as used herein, may relate to a set of one or more electronic circuits on a semiconductor material. For example, the electronic circuit may include electronic components and their interconnectors.

It should be understood that terms such as “on top of,” “above,” and “over,” as used herein, refer to a direction that is shown as vertical in the drawings, but need not be literally vertical with respect to gravity; generally, the device may be oriented in any direction with respect to gravity, without affecting its operation.

Implementation of the method and system of the present disclosure may involve performing or completing certain selected tasks or steps manually, automatically, or a combination thereof. Moreover, according to actual instrumentation and equipment of preferred embodiments of the method and system of the present disclosure, several selected steps may be implemented by hardware (HW) or by software (SW) on any operating system of any firmware, or by a combination thereof. For example, as hardware, selected steps of the disclosure could be implemented as a processor chip or a circuit. As software or algorithm, selected steps of the disclosure could be implemented as a plurality of software instructions being executed by a computer/processor using any suitable operating system. In any case, selected steps of the method and system of the disclosure could be described as being performed by a data processor, such as a computing device for executing a plurality of instructions.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

Although the present disclosure is described with regard to a “computing device”, a “computer”, or “mobile device”, it should be noted that optionally any device featuring a data processor and the ability to execute one or more instructions may be described as a computing device, including but not limited to any type of personal computer (PC), a server, a distributed server, a virtual server, a cloud computing platform, a cellular telephone, an IP telephone, a smartphone, a smart watch or a PDA (personal digital assistant). Any two or more of such devices in communication with each other may optionally comprise a “network” or a “computer network”.

No reference cited in this disclosure is to be considered as admitted prior art.

It should be appreciated that the above-described methods and apparatus may be varied in many ways, including omitting, or adding steps, changing the order of steps and the type of devices used. It should be appreciated that different features may be combined in different ways. In particular, not all the features shown above in a particular embodiment or implementation are necessary in every embodiment or implementation of the disclosure. Further combinations of the above features and implementations are also considered to be within the scope of some embodiments or implementations of the disclosure.

While certain features of the described implementations have been illustrated as described herein, many modifications, substitutions, changes, and equivalents will now occur to those skilled in the art. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations and embodiments described.

What is claimed is:

1. A system comprising:
a sensing field effect transistor (FET) including a first source region, first drain region, and a first sensing region;
a reference FET substantially identical to the sensing FET or sized according to a scaling factor relative to the sensing FET and including a second source region, second drain region, and a top gate formed from a covered second sensing region; and
a controller configured to determine a base voltage applied to the top gate that results in an electric field in the second sensing region that matches an electric field in the first sensing region.

2. The system of claim 1, wherein the controller uses a measured current to provide an indication of the electric field in the sensing FET and the reference FET, wherein the measured current is the current between the first source and drain regions and the current between the second source and drain regions.

3. The system of claim 1, wherein the controller uses measurable parameters that provide an indication of the electric field or of a work function in the sensing FET and the reference FET.

4. The system of claim 1, wherein the sensing FET further includes a first lateral gate or first back gate, and wherein the reference FET further includes a second lateral gate or second back gate.

5. The system of claim 4, wherein the controller is further configured to apply voltages to the first lateral gate or first back gate and to the second lateral gate or second back gate to thereby induce a conducting channel in both of the sensing and reference FETs for current flow therethrough from the respective source to drain regions.

6. A method for calibrating a sensing FET, comprising;
providing the sensing FET including a source region, drain region, and a first sensing region;
providing a reference FET having substantially the same structure and materials as the sensing FET and further including a top gate formed from a covering over a second sensing region of the reference FET; and
providing a controller and determining by the controller of a base voltage applied to the top gate that results in an electric field in the second sensing region that matches an electric field in the first sensing region.

7. The method of claim 6, further including, when the sensing FET is exposed to an analyte, using the controller to determine an analyte voltage applied to the top gate that results in an electric field in the second sensing region that matches an electric field in the first sensing region.

8. The method of claim 6, further including, when the sensing FET is exposed to an analyte, using the controller to determine an analyte voltage applied to the top gate when a measured current between the source and drain regions of the sensing FET is equivalent to the measured current between the source and drain regions of the reference FET.

9. The method of claim 5, wherein the sensing FET further includes at least one of a first lateral gate or first back gate, and wherein the reference FET further includes at least one of a second lateral gate or second back gate.
